(19) United States
(12) Patent Application Publication
(10) Pub. No.: US 2007/0050723 A1
(43) Pub. Date: Mar. 1, 2007

(54) VIDEO DISPLAY AND DISPLAYING METHOD THEREOF

(75) Inventor: Chia-Chang Hsieh, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/466,492

(22) Filed: Aug. 23, 2006

(30) Foreign Application Priority Data
Aug. 26, 2005 (TW) 94129368

(51) Int. Cl. G06F 9/00

(52) U.S. Cl. 715/764; 715/810; 715/771; 725/37

(57) ABSTRACT

A video display device including a plurality of keys, a microprocessor and a display panel is disclosed. The keys are disposed on an outer surface of the display device, and the microprocessor is disposed inside the display device. The microprocessor is electrically coupled with the keys. The display panel is used for displaying an image. When one of the keys is pressed or touched, the display panel displays a menu. The menu includes multiple instructions corresponding to the function of the keys. Each instruction of the menu corresponds to the sequence and arrangement of each key.

This application claims the benefit of Taiwan application Serial No. 94129368, filed Aug. 26, 2005, the subject matter of which is incorporated herein by reference.

### BACKGROUND OF THE INVENTION

1. Field of the Invention

The invention relates to a video display device and displaying method thereof, and more particularly to a video display device, which has keys with positions corresponding to the menus and a displaying method therefore.

2. Description of the Related Art

The development of the display device has been decades. From the traditional cathode vacuum tube display, such as a conventional television to the present liquid crystal display and plasma display, the technology in this field is getting to a stage of maturity.

FIG. 1 is a three-dimensional diagram of a conventional video display device. The video display device has a plurality of keys such as key 101 to key 104. For instance, the key 101 is a power key; the key 102 is a volume adjusting key; the key 103 is a brightness adjusting key and the key 104 is an escaping key. When users would like to press one of these keys, they have to look at and read the instructions placed below or beside the keys, such as the instructions placed below the key 101 to key 104 shown in the FIG. 1 so as to know the function of the keys. Users can also use a trial and error method by pressing one key after another. They might have luck finding the right key for the required function on the first or second trial. However, if there are quite a few keys, there seems to be a high probability of pressing the wrong key. When users crane their necks to read the instructions near the keys, their sight is often obstructed by the obstacle 105. For example, the television could be put in the cabinet, so the cabinet is likely to obstruct the sight of users.

Users can also label the keys 101 to 104 by using notable stickers or papers so that users can press the correct key more easily. However, doing such way will spoil the good-looking appearance of the whole device.

### SUMMARY OF THE INVENTION

It is therefore an object of the invention to provide a video display device and displaying method thereof which provides clear instruction for users to press the correct key. The improvement in efficiency of using the video display device is achieved accordingly.

It is an object of the invention to provide a video display device, which includes a plurality of keys, a microprocessor and a display panel. The microprocessor is electrically coupled with the keys. The display panel is used to display an image. When one of the keys is pressed or touched, the display panel displays a menu. The menu contains several instruction items, each showing the function of the corresponding key. The positions of these instruction items are arranged to correspond to the relevant keys.

It is an object of the invention to provide another displaying method of a video display device. The video display device includes a microprocessor and a display panel. A plurality of keys are disposed on an outer surface of the video display device. The microprocessor is disposed inside of the video display device and electrically coupled with the keys. The display panel is used to display a menu of the keys. In the displaying method of the invention, firstly, one of the keys is pressed and a pressing signal is generated and outputted to the microprocessor. The display panel controlled by the microprocessor displays the menu, which is corresponding to the instructions of the keys.

It is an object of the invention to further provide a displaying method for a video display device which is equipped with a plurality of keys, a microprocessor electrically coupled with the keys, a display panel and a plurality of sensors electrically coupled with the microprocessor. The display panel is used to display a menu of the keys. In the displaying method, first of all, when the sensor detects one of the keys is touched, a first signal is generated. The first signal is then transmitted to the microprocessor; and then the display panel controlled by the microprocessor generates a menu which is corresponding to the instructions of the keys.

Other objects, features, and advantages of the invention will become apparent from the following detailed description of the preferred but non-limiting embodiments. Then following description is made with reference to the accompanying drawings.

### BRIEF DESCRIPTION OF THE DRAWINGS

FIG. 1 (Prior Art) is a three-dimensional diagram of a video display device.

FIG. 2A is a three-dimensional diagram according to a first embodiment of the invention.

FIG. 2B is a block diagram showing a video display device according to a first embodiment of the invention.

FIG. 2G is a flow chart showing a video-displaying method according to a first embodiment of the invention.

FIG. 3 is a block diagram showing a video display device according to a second embodiment of the invention.

FIG. 4 is a flow chart showing a video display method according to a second embodiment of the invention.

### DETAILED DESCRIPTION OF THE INVENTION

### First Embodiment

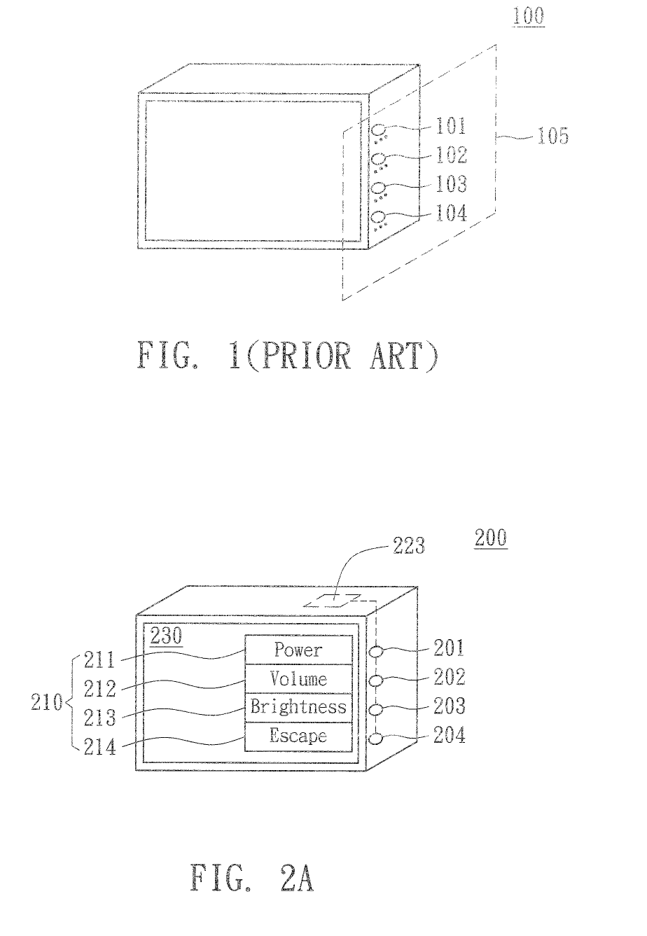

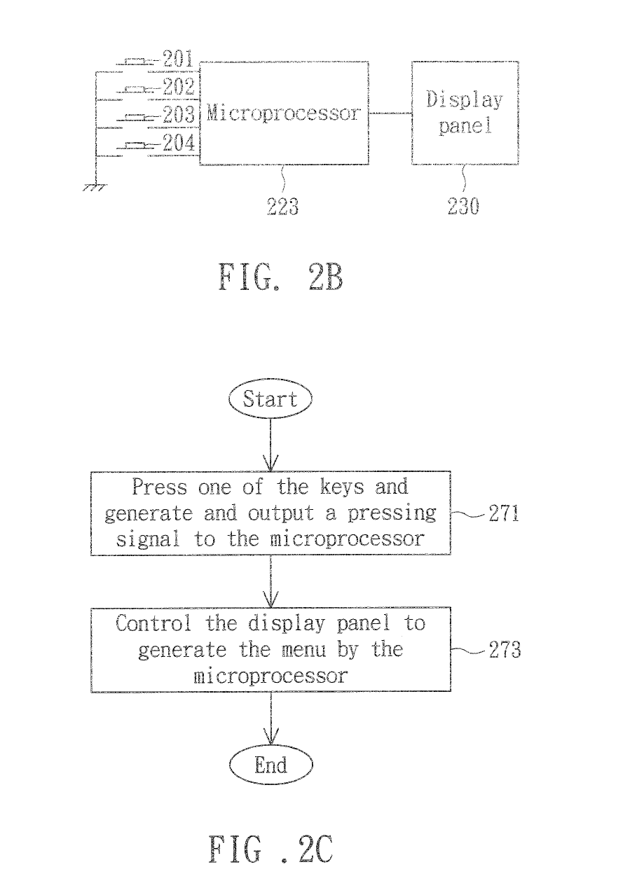

Referring to FIG. 2A, a three-dimensional diagram of a display device according to the first embodiment of the invention is shown. The display device 200 is a liquid crystal display (LCD) for instance, which has a microprocessor 223, a display panel 230 and a plurality of keys. The keys are the key 201 to 204 for instance, which can be disposed on an outer surface of the display device 200. The microprocessor 223 is disposed inside the display device 200 and electrically coupled with every key 201 to 204. The display panel 230 is used to display an image.

FIG. 2B shows a block diagram of the video display device according to the first embodiment. Referring to FIGS. 2A and 2B, when the user motivates, by pressing or touching, any one of the keys 201-204, such as the key 204, a first pressing signal is outputted to the microprocessor 223. The microprocessor 223 controls the display device 230 to generate a menu 210. The menu 210 includes a plurality of instructions 211 to 214 which respectively corresponds to the function of each key 201 to 204. For example, as shown in FIG. 2A, the “escape” instruction 214 in the menu 210 corresponds to the function of the key 204 and the “brightness control” instruction 213 corresponds to the function of the key 203. With the aid of the menu 210, users can easily motivate the correct key without fumbling around. While any of the desired keys, such as the volume adjusting key 202, is motivated, an instructional signal is generated and outputted to the microprocessor 223. The microprocessor 223 will then perform the volume adjustment function accordingly. In the past, users need to read the instructions of the keys printed on the surface of the video display device carefully or try one key after another by the trial and error method until a correct key corresponded to the required function is pressed. The display device disclosed by the first embodiment helps to reduce users' confusion. Users can find the corresponding key with the assistance of the displayed menu by pressing the key once only.

Referring to FIG. 2C, a flow chart of the video display method according to the first embodiment is shown. Firstly, in step 271, by pressing one of the keys 201 to 204, a pressing signal is generated and outputted to the microprocessor 223. Finally, in step 273, the microprocessor 223 controls the display panel 230 to generate the menu 210.

### Second Embodiment

Referring to FIG. 2A and FIG. 3, which shows a block diagram of the video display device according to the second embodiment, unlike the first embodiment, the video display device of the second embodiment further includes a sensor 370. The sensor 370 is electrically coupled with every key 201 to 204. The sensor 370 is an electrostatic sensor, a thermal sensor or an image sensor for instance. When users want to adjust volume by pressing the key 202, they only need to gently touch any one of the keys 201 to 204 by their fingers instead of pressing the keys. When placing fingers on one of the keys 201 to 204, the sensor 370 is sensed and generates a first signal. Then, the sensor 370 outputs a second signal to the microprocessor 223. The microprocessor 223 controls the display panel 230 to generate the menu 210. Similar to the first embodiment, users can find the key for the required function from reading the instructions of the displayed menu 210.

In the first embodiment and the second embodiment, each key instruction of the menu can also be arranged to be corresponding to the sequence of the keys. For example, each key instruction on the menu is level with the keys. Users are able to press the correct key simply by reading the key instruction that is shown at the same level with the key of the required function. In the second embodiment, for example, the sensor 370 is an electrostatic sensor and the surface of the keys 201 to 204 is made of metal. When users put their fingers on the surface of the keys gently, the electrostatic induction makes variation of the charge amount of the metal surface to generate the first signal. Then, the sensor 370 outputs the second signal to the microprocessor 223 after sensing the variations of the charge amount. The microprocessor 223 controls the display panel 230 to generate the menu. Certainly, the sensor 370 could be an infrared image sensor or a temperature sensor. The infrared image sensor determines whether fingers touch the keys or not by catching the images. Yet, the temperature sensor determines whether the key is touched by sensing the temperature above target value to display the menu. Therefore, users could select the key to be pressed according to the instruction display on the menu.

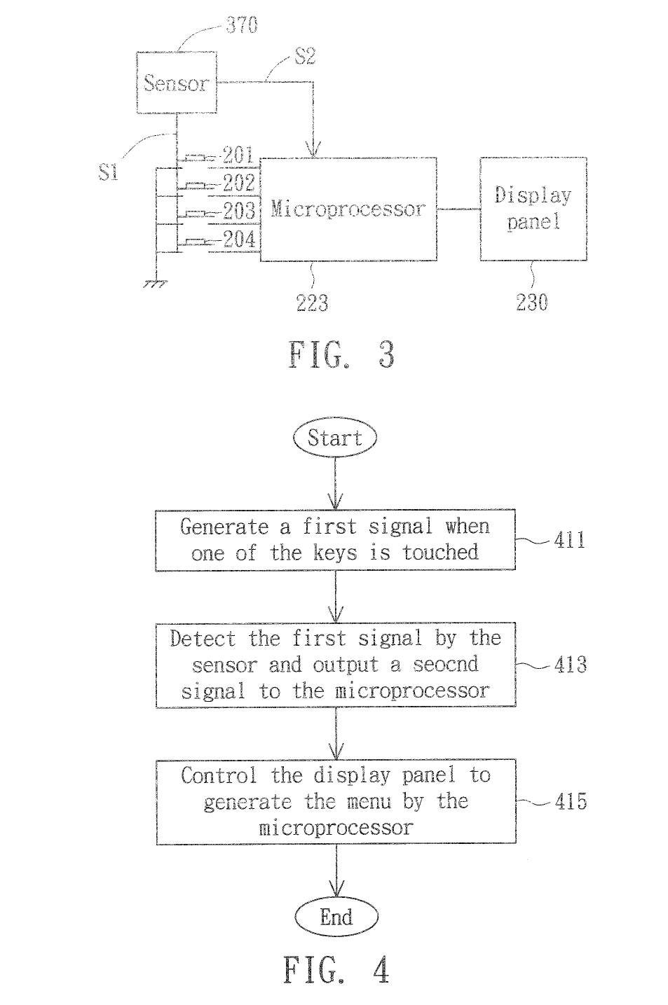

Referring to FIG. 4, a flow chart of the video-displaying method according to the second embodiment is shown. Firstly, in the step 411, when one of a plurality of keys 201 to 204 is touched, the first signal is generated. Secondly, in the step 413, the sensor 370 senses the first signal and outputs the second signal to the microprocessor 223. Finally, in the step 415, the microprocessor 223 controls the display panel 230 to generate the menu 210.

According to he video display device disclosed by the above-mentioned embodiments of the invention, the menu can be displayed on the display panel by pressing the keys or by means of the sensor disposed in the video display device, Users only need to touch keys gently rather than to use the conventional trial and error method to try one key after another, or popping one's head to see the explanation around the keys. Accordingly, the two embodiments mentioned above can provide more friendly user interface for users.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video display device, comprising:
a plurality of keys,
a microprocessor, electrically coupled with the keys, and
a display panel, controlled by the microprocessor for displaying an image;
wherein when one of the keys is motivated, the display panel displays a menu, the menu corresponds to the arrangement and the sequence of the keys.

2. The device according to claim 1, wherein the menu has a plurality of instructions, each of the instructions is level with one of the corresponding keys.

3. The device according to claim 1, wherein the device further comprises a sensor, and the sensor is electrically coupled with the keys.

4. The device according to claim 3, wherein the sensor is an electrostatic sensor electrically coupled with each of the keys, when one of the keys is motivated, the microprocessor controls the display panel to display the menu.

5. The device according to claim 4, wherein the sensor is a temperature sensor disposed on each of the keys, and when one of the keys is motivated, the microprocessor controls the display panel to display the menu.

6. The device according to claim 4, wherein the sensor is an image sensor electrically coupled with each of the keys, when one of the keys is motivated, the microprocessor controls the display panel to display the menu.

7. The device according to claim 1, wherein the keys are motivated by pressing.

8. The device according to claim 1, wherein the keys are motivated by touching.

9. A displaying method of a video display device, the device comprising a microprocessor and a display panel, a plurality of keys disposed on the video display device, the microprocessor disposed inside the video display device and electrically coupled with the keys, the display panel used to display an image, the displaying method comprising:
generating a pressing signal when one of the keys is motivated;
outputting the pressing signal to the microprocessor; and
controlling the display panel to generate a menu, wherein the menu is corresponding to the arrangement of the keys.

10. The displaying method according to claim 9, wherein the pressing signal is generated when one of the keys is pressed.

11. The displaying method according to claim 9, wherein the pressing signal is generated when one of the keys is touched.

12. A displaying method of a video display device, the device comprising a microprocessor, a display panel and a sensor, a plurality of keys disposed on the video display device the microprocessor disposed inside the video display device and electrically coupled with the keys, the display panel used to display an image, the sensor electrically coupled with the keys, the displaying method comprising:
generating a first signal when one of the keys is motivated;
outputting a second signal to the microprocessor; and
controlling the display panel to generate a menu, wherein the menu is corresponding to the arrangement of the keys.

13. The displaying method according to claim 12, wherein the first signal is generated when one of the keys is pressed.

14. The displaying method according to claim 12, wherein the first signal is generated when one of the keys is touched.
